(19) United States
(12) Patent Application Publication
(10) Pub. No.: US 2002/0107936 A1
(43) Pub. Date: Aug. 8, 2002

(54) System and method for displaying emergency information on a user computer

(76) Inventor: Thomas C. Amon, Santa Ana, CA (US)

Correspondence Address: STETINA BRUNDA GARRED & BRUCKER, 75 ENTERPRISE, SUITE 250, ALISO VIEJO, CA, 92656, US

(21) Appl. No.: 10/021,141

(22) Filed: Dec. 12, 2001

Related U.S. Application Data
(60) Provisional application No. 60/255,544, filed on Dec. 13, 2000.
(60) Provisional application No. 60/255,594, filed on Dec. 13, 2000.

(51) Int. Cl. G06F 15/16

(52) U.S. Cl. 709/217

(57) ABSTRACT

The present invention may be regarded as a method for a server computer to provide emergency information to a user computer connected to a system of networked computers. The server computer on the system of networked computers receives a request for an action from the user computer over the system of networked computers. The server computer interrupts the request for the action by sending emergency information to be displayed on the user computer to the user computer over the system of networked computers.

### CROSS-REFERENCE TO RELATED APPLICATIONS

This application claims the benefit of U.S. provisional application No. 60/255,594, filed Dec. 13, 2000, the entire contents of which are hereby incorporated by reference, and U.S. Provision al application 60/255,544 filed Dec. 13, 2000, the entire contents of which are hereby incorporated by reference.

### STATEMENT RE: FEDERALLY SPONSORED RESEARCH/DEVELOPMENT

(Not Applicable)

### BACKGROUND OF THE INVENTION

The present invention relates generally to providing emergency information and more specifically, the present invention relates to a system for automatically providing emergency information over a system of networked computers, such as the Internet.

Computer systems in general are known. A typical computer system includes a computer, a keyboard, a mouse, and a monitor. Additionally, the computer includes a central processing unit (CPU) and random access memory (RAM) and allows various software programs to be used. Further, the computer system may include a modem, an Ethernet card or other similar device for connecting to a system of networked computers, such as the Internet.

The Internet provides a useful technique for making information available to a variety of individuals each of whom may be located at a variety of different locations. Indeed, within the vast Internet environment, individuals can access information tools from remote locations. The Internet, which originally came about in the late 1960's, is a computer network made up of many smaller networks spanning the entire globe. The host computers or networks of computers on the Internet allow public or private access to databases containing information in numerous areas of expertise. Hosts can be sponsored by a wide range of entities including, for example, universities, government organizations, commercial enterprises and individuals.

Internet information is made available to the public through servers running on an Internet host. The servers make documents or other files available to those accessing the host site. Such files can be stored in databases and on storage media such as, for example, optical or magnetic storage devices, preferably local to the host.

Networking protocols can be used to facilitate communications between the host and a requesting client. Transmission Control Protocol/Internet Protocol (TCP/IP) is one such networking protocol. Computers on a TCP/IP network utilize unique identification codes allowing each computer or host on the Internet to be uniquely identified. Such codes can include an Internet Protocol (IP) number or address and corresponding network and computer names.

Created in 1991, the World-Wide Web (Web, or www) provides access to information on the Internet, allowing a user to navigate Internet resources intuitively, without IP addresses or other specialized knowledge. The Web comprises hundreds of thousands of interconnected “pages” or documents that can be displayed on a user's computer monitor. The web pages are provided by hosts running special servers. Software that runs these web servers is relatively simple and is available on a wide range of computer platforms including personal computers (PCs). Equally available is web browser software used to display web pages, as well as traditional non-web files, on the user's system.

The Web is based on the concept of hypertext and a transfer method known as Hypertext Transfer Protocol (HTTP). HTTP is designed to run primarily over TCP/IP and uses the standard Internet setup where a server issues the data and a client displays or processes the data. One format for information transfer is to create documents using Hypertext Markup Language (HTML). HTML pages are made up of standard text as well as formatting codes indicating how to display the page. A browser reads these codes to display the page. The Web also uses the File Transfer Protocol (FTP) to transmit files between hosts. In particular, a method known as “anonymous FTP” allows a user to receive a file from a server without the server learning the identity of the user.

Each web page may contain pictures and sounds in addition to text. Associated with certain text, pictures or sounds are connections, known as hypertext links, to other pages within the same server or even on other computers within the Internet. For example, links may appear as underlined or highlighted words or phrases. Each link is directed to a web page by using a special name called a Uniform Resource Locator (URL). URLs enable the browser to go directly to the associated resource, even if it is on another web server.

In addition to the Internet which allows for general, public retrieval of information, other means of accessing such information exist and are commonly utilized. For example, direct modem connections between two computers, proprietary internal networks within large institutions and organizations, or the like, are equally available and useful means for accessing catalogued information stored in databases.

Many users are not aware when emergency situations arise, such as natural disasters, dangerous weather, or the like. Even if such individuals are aware of such a situation, these individuals have traditionally turned to television or radio to obtain emergency information. This information may not be available via these devices or alternatively, it may be difficult for a user to find the correct station on the radio or television to obtain the desired information. Users that have used the Internet to find such emergency information must first find a web page that potentially provides this information. Additionally, these Internet users still may not receive updated emergency information as the web pages the user views may not necessarily be updated immediately. Therefore, a need has arisen for a system for providing emergency information over a system of networked computers.

### BRIEF SUMMARY OF THE INVENTION

An aspect of the present invention may be regarded as a method for a server computer to provide emergency information to a user computer connected to a system of networked computers. The server computer on the system of networked computers receives a first request for an action from the user computer over the system of networked computers. The server computer interrupts the first request for an action by sending emergency information to be displayed on the user computer to the user computer over the system of networked computers.

Information responsive to the first request for an action may be sent from the server computer to the user computer over the system of networked computers. The information that is responsive to the first request for an action may be sent after an amount of time or after receiving a second request for an action.

The second request for an action may be a request for additional emergency information that is generated in response to a user clicking on a specified area in the emergency information that is displayed on the user computer. The server computer may then send additional emergency information in response to the second request for additional emergency information.

The emergency information may pertain to a weather-related emergency or a computer virus.

The first request for an action may be a request to view a web page.

The emergency information may be provided by a governmental entity.

The emergency information may be provided to a plurality of user computers.

Another aspect of the present invention may be regarded as a method for receiving emergency information at a user computer connected to a system of networked computers. A first user request for an action is received. The first user request for an action is transmitted from the user computer to a server computer over the system of networked computers. Emergency information is received in response to the first user request for the action instead of receiving information that is responsive to the first request for action. The emergency information is displayed on the user computer.

The emergency information may fill the entire screen display on the user computer.

The emergency information may flash and/or be in a color that is easy to notice.

### BRIEF DESCRIPTION OF THE DRAWINGS

These, as well as other features of the present invention, will become apparent upon reference to the drawings, wherein:

FIG. 1 illustrates an overview of a computer according to exemplary embodiments of the present invention;

FIG. 2 illustrates a typical computer display screen;

FIG. 3 illustrates a computer display screen including a browser display that is relocated so that the menu and left bar are off the screen;

FIG. 4 illustrates an expanded display;

FIG. 5 illustrates a display screen that uses all the pixels of a computer display screen to display emergency information; and

FIGS. 6-9 illustrate overviews of various embodiments of the present invention.

### DETAILED DESCRIPTION OF THE INVENTION

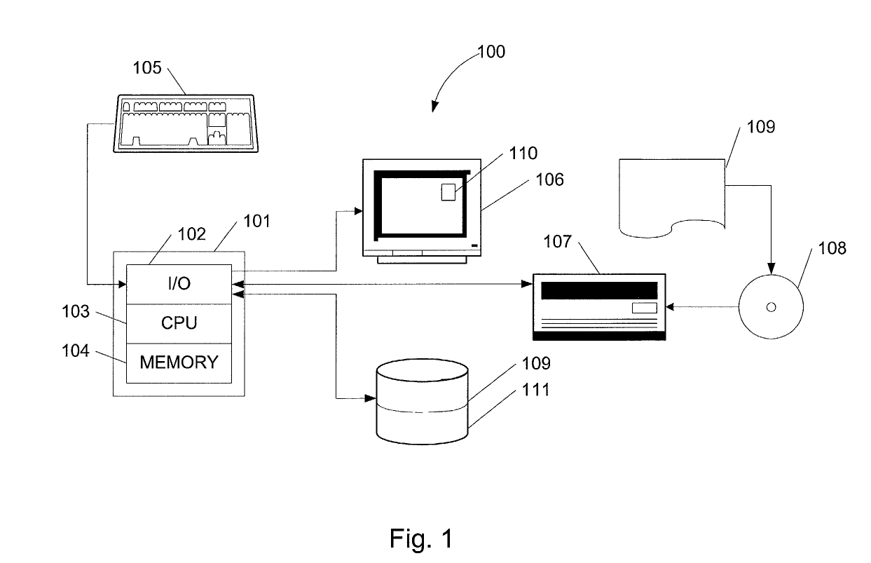

Referring now to the drawings wherein the showings are for purposes of illustrating preferred embodiments of the present invention only, and not for purposes of limiting the same, FIG. 1 illustrates a computer 100 in which a system of the present invention may be embodied. A general purpose workstation computer 100 comprises a processor 101 having an input/output (I/O) section 102, a central processing unit (CPU) 103 and a memory section 104. The I/O section 102 is connected to a keyboard 105, a display unit 106, a disk storage unit 109 and an external media drive, such as a CD-ROM drive unit 107. The CD-ROM unit 107 can read a CD-ROM medium 108, which typically contains programs and data 109 which may be displayed as information 110 on the display 106.

The computer 100 may be a personal computer, desktop computer, laptop computer, set top box, web access device (such as WEB TV™ by Microsoft® Corporation), or the like. Use of computers also contemplates other devices similar to or incorporating computers, such as personal computers, television interfaces, kiosks, and the like.

The system of the present invention may be any system of multiple computers that are directly or indirectly interconnected by any type of electronic connections. Such electronic connections include, but are not limited to, connections via hardwire, Ethernet, token ring, modem, digital subscriber line, cable modem, wireless, optical, radio, satellite, and combinations thereof. Such connections may be implemented using copper wire, fiber optics, radio waves, coherent light, or other media. The system of networked computers may be the Internet, an intranet, a secure virtual private network (VPN), or any other system of computers that are interconnected by electronic connections. As used herein, the term “network” refers to any such system of networked computers, including the Internet. Likewise, as used herein, the expression “providing a network” alternatively means creating a network specifically for the purpose of facilitating the system of the present invention, or simply using any existing network for that purpose.

In exemplary embodiments, the present invention may include a system of networked computers, wherein general purpose computers, workstations, or personal computers are interconnected directly or indirectly by any type of electronic connections. Information transmitted from the user or other entities is sent from one such computer to other similar computers. Additionally, the system of network computers may also include wireless devices, such as a personal digital assistant (PDA), cellular or mobile telephone, electronic handheld unit for the wireless receipt and/or transmission of data, such as a BLACKBERRY™ (Research In Motion Limited Corporation), or the like.

Access by a computer 100 to the system of networked computers may be made via the World Wide Web based on the URL or IP address provided by a user from a computer terminal. Internet browsing software or a web browser provides a user access to the URL or IP address of the desired web page and the electronic information stored therein.

In exemplary embodiments of the present invention, emergency information is provided to users on a system of networked computers, such as the Internet. The emergency information is automatically sent to a user connected to the system of networked computers when the user performs an action. For example, this action could be requesting a web page, providing a URL to view a web page, clicking on a hyperlink, clicking on an area of a web page, or any other such action that a user may perform on the system of networked computers.

To automatically provide the user with the emergency information, the user's action is interrupted. Instead of performing the user's action, the user is shown the emergency information on the user's screen. The action may be interrupted using a message server 150 that is connected to the system of networked computers. The message server 150 automatically provides the user's computer with the emergency information. The user's computer 100 then automatically displays the emergency information.

The emergency information may include the ability to be acted upon by the user to obtain further information, such as by clicking on an area marked “obtain further information.” Alternatively, if the user acts upon any area of the emergency information, more information may be provided to the user. Such additional information may include, for example, a list of additional web pages to visit to obtain additional information, hyperlinks to web pages having additional information, instructions on how to protect oneself from the emergency conditions, information on telephone numbers a user may call, information on e-mail addresses that a user may use to request assistance, information on the area that the emergency is affecting, or the like. Alternatively, the emergency information may not need to provide the user with further information as all of the pertinent information may be provided in the emergency information.

After viewing the emergency information, the user may be returned to the action that the user had originally requested, for example by directing the user to the web page that he or she had originally requested. Alternatively, after viewing the emergency information, the user may automatically be directed to a web page that provides the user with the additional information as described above.

In exemplary embodiments, after the emergency information is shown to the user on the user's screen for a specified amount of time, the emergency information is automatically removed, and the action requested by the user is performed.

The emergency information may include information regarding emergencies, public service announcements, or the like. For example, the information may pertain to natural disasters, weather, dangerous conditions, snow, rain, hail, thunder, lightning, a fire, a hurricane, a tornado, an earthquake, a typhoon, a flood, a tsunami, criminal activity, disease epidemics, viral outbreaks, war, a nuclear disaster, or any other such man-made act, natural act or act of God.

Moreover, the emergency information may be used within an intranet, such as within a company. For example, if a company knows that a computer virus is spreading through its system, the emergency information may be provided to its company employees via the company's intranet. Moreover, the company could use the system of the present invention to provide its employees with other emergency information, such as that the company's intranet is about to be shut off.

Additionally, if police know that a criminal is in a local area, individuals in the local area may be provided with pertinent emergency information. This could assist the police in capturing the offender and/or protecting the public from the offender.

Further, the emergency information may include audio or video images to further convey the emergency information. The emergency information may flash or be in a color, such as red, that is easy to notice.

The emergency information may be directed to users world-wide, nationally, state-wide, county-wide, locally, company-wide, or to a specific individual. Alternatively, the emergency information may be provided to all users fitting a demographic profile or visiting certain web pages. Alternatively, the emergency information may be provided to all users.

In various embodiments, emergency information may be directed to specific users using access providers. Access providers may maintain information about the users that would indicate where they live, where they are located, what their demographics are, and the like. This information may be used to target the emergency information to specific users. Alternatively, information about localities may be stored such that the system can send an emergency message to users in a particular locality. The system of the present invention may store information on particular users such that the system could target the intended users. Alternatively, users may register with the system such that they are sent emergency information. Further, the system may know a preferred language of the user, sending emergency information in that preferred language.

Exemplary embodiments of the present invention provide that a governmental entity, such as a federal, state or local government, may decide when and what type of organizations may send out the information. Further, test messages may be sent out randomly or on a regular basis. Such test messages may instruct users that “this is only a test.”

The emergency information may be provided in a separate window on the computer, such as in a separate window of the user's Internet browsing software. Alternatively, the emergency information may be provided within the current window of the Internet browsing software.

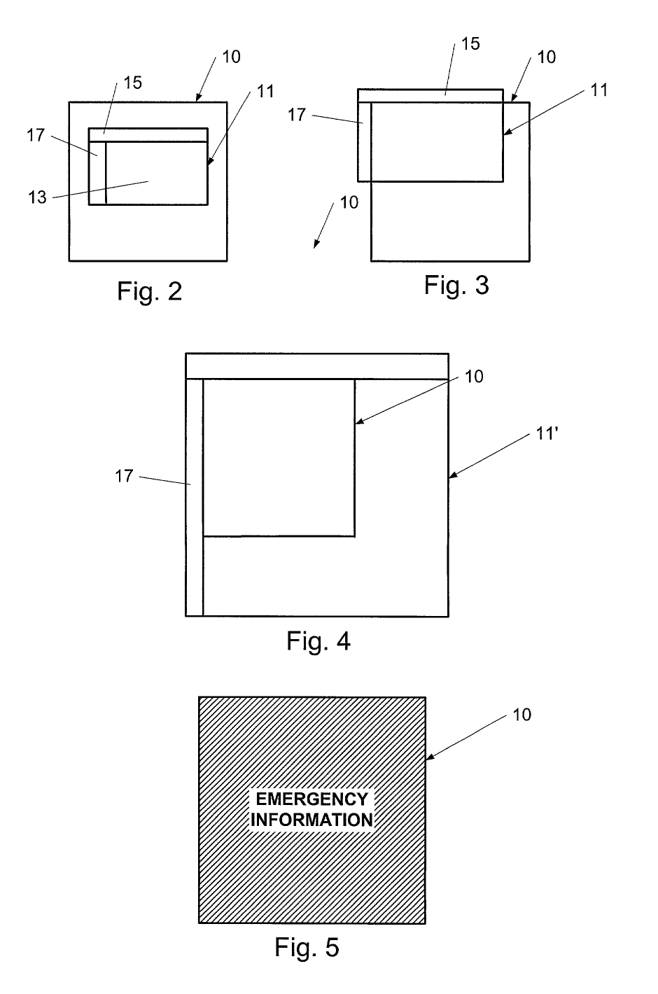

Alternatively, the emergency information may fill up the entire screen of the user's computer. An exemplary embodiment illustrating how to fill up the entire screen with the emergency information is shown in FIGS. 2-5 and described next.

FIG. 2 illustrates a typical computer display screen 10, which may be, for example, a CRT monitor interconnected with a conventional personal computer (PC) running a web browser. In FIG. 2, the browser is open, resulting in a display 11. The display 11 may include a viewing area 13, a menu area 15 and a left bar 17 such as is shown in FIG. 2. It will be appreciated that other browser configurations may be possible in alternate embodiments of the invention. For example, there may not be any bar or there may be a right bar instead of a left bar. In exemplary embodiments, the web browser is Internet Explorer® 5.5. Other web browsers may be adapted to provide the advantages of the method according to the invention. The method according to the invention may be triggered by receipt from a server of contents to be displayed (e.g., an HTML page) and a Java® script routine to control the browser display.

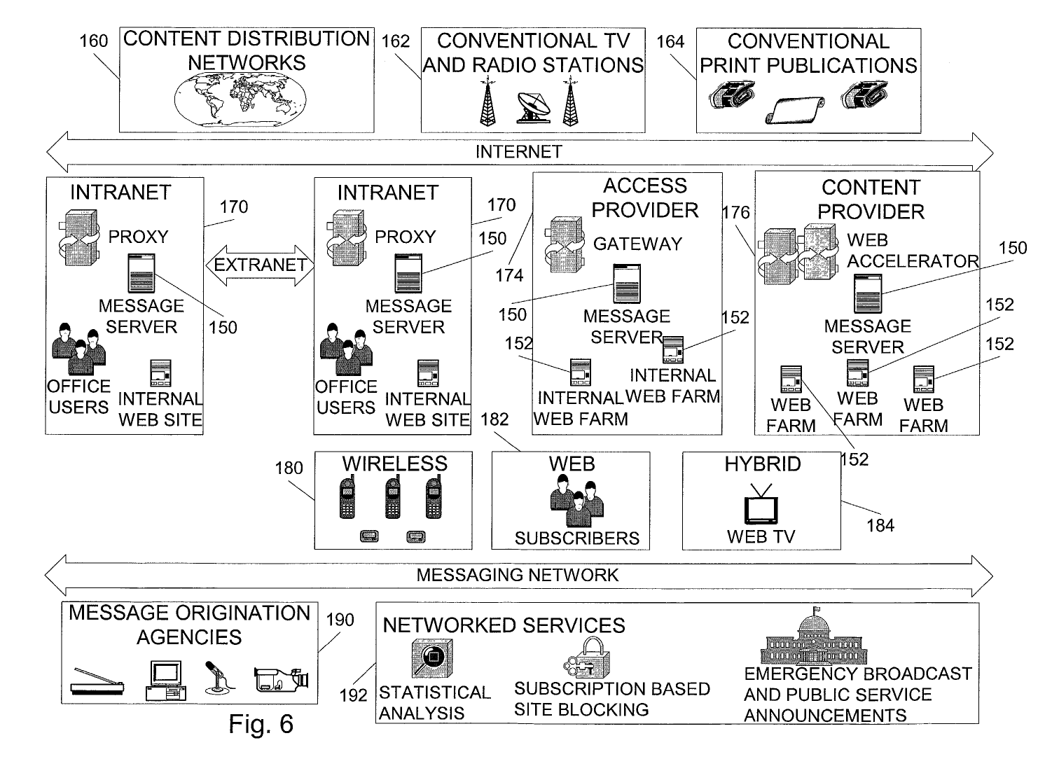

In exemplary embodiments, the browser display 11 is relocated so that the menu 15 and left bar 17 are off the screen 10, as shown in FIG. 3. This may be achieved by Java® script that calls a browser function to move the browser display's point of origin to the following location:

y—menu height

x—1

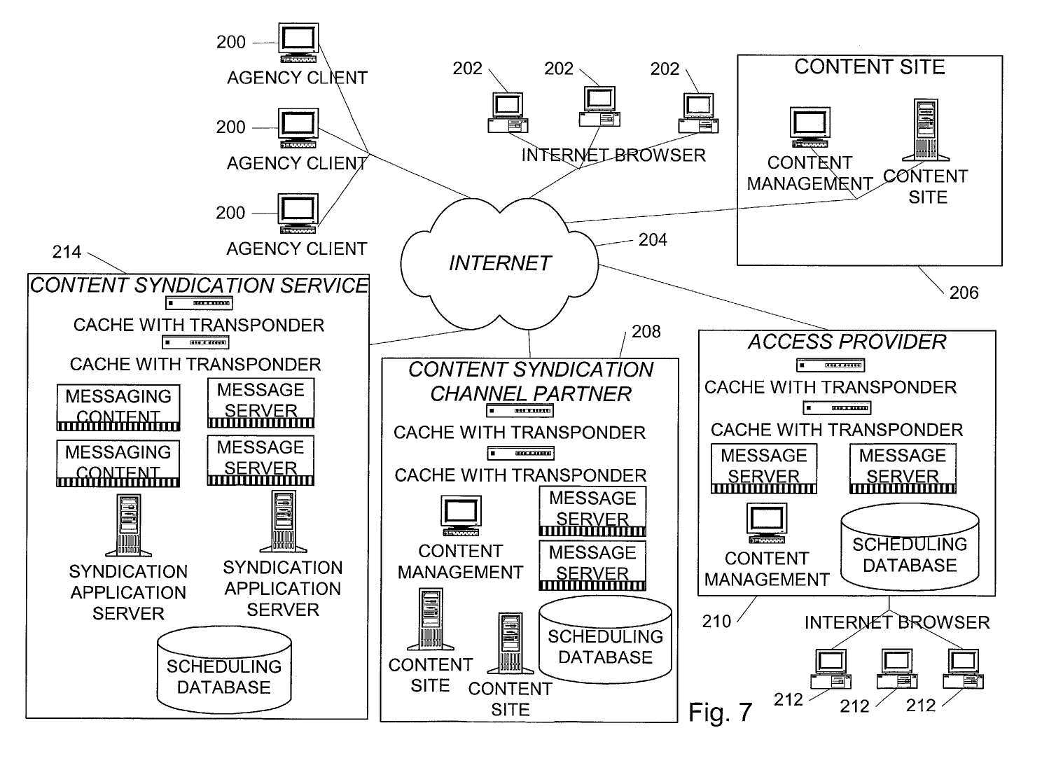

Next, the screen width (screen x) and height (screen y) are added to the existing display size resulting in expanding the display 11 so that it is exactly larger than the size of screen 10 by the dimensions of the original browser display 11. This results in an expanded display 11′, as shown in FIG. 4. This expansion step is facilitated by the ability to read the physical screen pixels in Java®.

Next, a one cell HTML table is defined, which is screen x/y (“x over y”) . In this manner, all pixels of the screen are made available to display the emergency information.

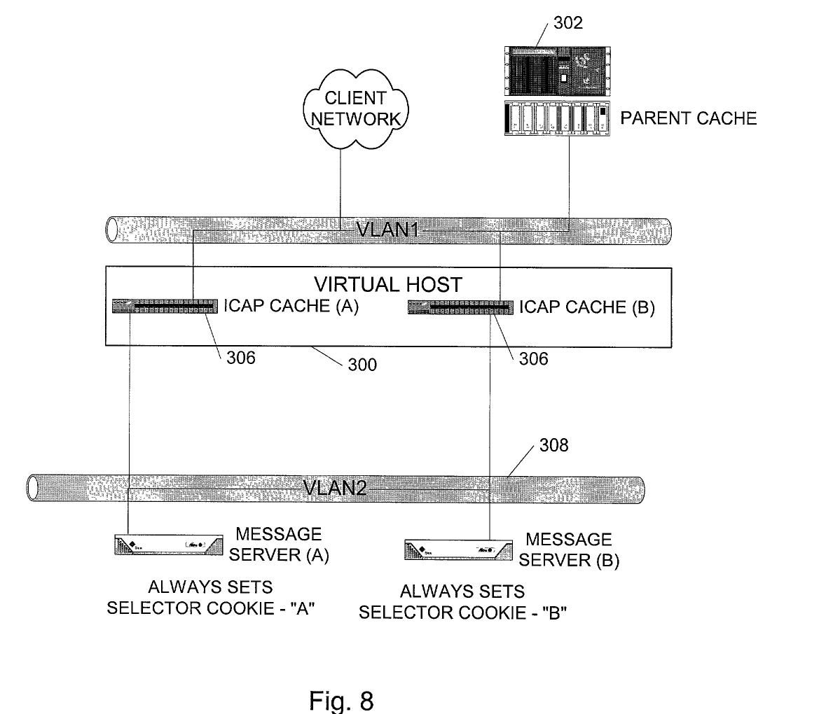

When full screen mode is entered, the emergency information is presented using all of the pixels of the screen, as shown in FIG. 5. The emergency information has the inherent ability to automatically fill the entire screen once all of the pixels are made available for display purposes.

After the emergency information is presented, the process is reversed to return to the original browser display state shown in FIG. 2. The duration of the presentation of the display of the emergency information may be determined by a time-out operation or other technique known to those skilled in the art. The steps used in this reverse process are: (1) relocate to saved x/y, (2) re-dimension by -screen x/-screen y, and (3) Navigate -1. The first step (1) relocates the browser display origin to the original location x/y which has been saved. The second step re-dimensions the display from the enlarged form shown in FIG. 4 back to normal size, thereby returning to the original state. The third step executes a refresh, which restores the original frame set. The second step (2) may be implemented using a “hard code” technique or by equivalent approaches. The above method is implemented by a Java® script program transmitted from a server along with the display content. An example of such a program is as follows:

When the page is loaded into the browser the following is executed first.

<=====Calculate Current Browser and Physical Screen parameters=====>

var xoffset=top.window.screen.width −top.window.screen.availWidth;

var yoffset=top.window.screen.height −top.window.screen.availHeight;

var origx=top.window.screenLeft−xoffset;

var origy=top.window.screenTop−yoffset;

var destx=0−xoffset;

var desty=0−yoffset;

var destwidth=top.window.screen.width+xoffset;

var destheight=top.window.screen.height+yoffset;

top.window.moveTo(0, 0);

The Ideal Location of the left edge is 1 pixel to the left of the physical leftmost pixel

destx=(destx-top.window.screenLeft)−1;

The Ideal Location of the Top edge is 1 pixel above the physical top most pixel but we also have to account for the height of the menu areas

desty (desty-top.window.screenTop+yoffset−1;

Calculate the location where the browser will be restored to

origx=origx−4;

origy=(origy−top.window.screenTop)+yoffset;

Create the Restore Function that will be loaded into the browser

newContent+=“<script language=Javascript>\r\n”;

newContent+=“<<!--\r\n”;

newContent+=“function restoreme(){\r\n”;

newContent+=“top.window.moveTo(“+origx+“,”+origy+”);\r\n”;

newContent+=“top.window.resizeBy(−“+destwidth+“,−”+destheight+”);\r\n”;

newContent+=“top.history.go(−1);\r\n”;

newContent+=“}\r\n”;

Make a one Cell Table that is exactly the screen width so that the centering function within the message will work.

newContent +=“<TABLE><TR><td width=”+top.window.screen.width+“valign=top align=center border=0 cell spacing=0 cell padding=0>\r\n”;

<- - - - - Actual Message Inserted Here - - - - - >Close the one cell table that is around the message content

newContent+=“<\td><\tr><\table>\r\n”;

<======= End of message creation by the browser script =======>

Move the Browser Off Screen

top.window.moveTo(destx,desty);

Size the Browser Larger Than the Screen Pixels

top.window.resizeBy(destwidth,destheight);

Overwrite the Browser Content with the new content

top.document.write(newContent);

top.document.close( );

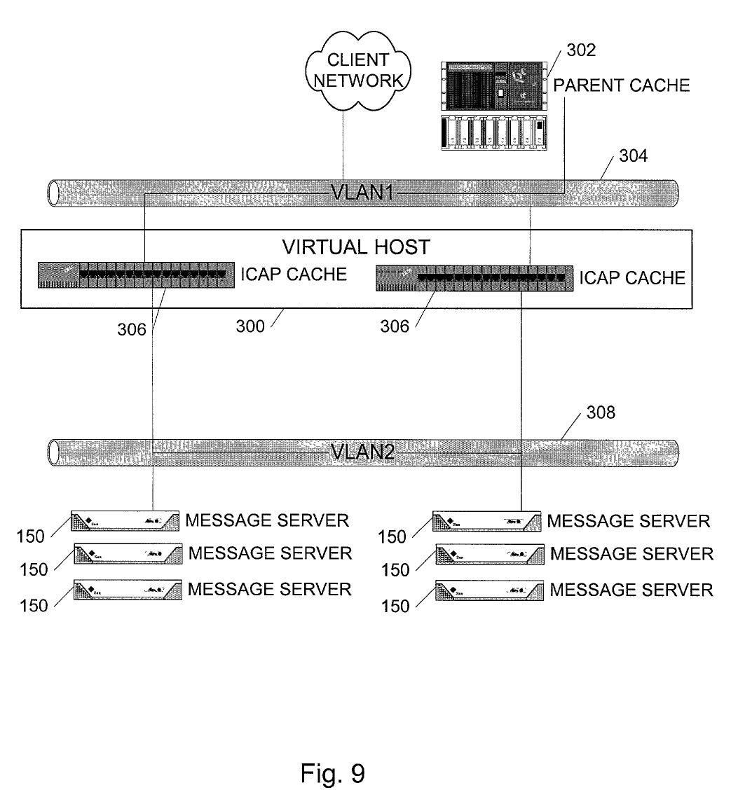

FIGS. 6-9 illustrate overviews of various embodiments of providing emergency information to users on the Internet.

FIG. 6 illustrates an overview of one embodiment of the present invention. Distribution networks 160, radio and television 162, and print publications 164 are shown. Users must hope that these providers provide them with the desired emergency information. However, under the present invention, emergency information may also be sent to these providers. For example, under the present invention, emergency information may be transmitted to content distribution networks 160, such as radio, television, and print. In exemplary embodiments of the invention, the system can broadcast this information to these providers without any action by the user. Therefore, a user may be watching a program on a television station and the program may be interrupted by the system of the present invention with the emergency broadcast. The message server 150 of the system may be connected to individual users or at the station. When an emergency broadcast is desired to be sent, the message server 150 interrupts the broadcast of the program, replacing it with the emergency broadcast. Alternatively, the emergency information may be shown in addition to the program, such as on the bottom or top of the television screen.

In exemplary embodiments of the present invention, users are connected to an intranet 170 visiting various internal web sites, such as is shown in FIG. 6. Alternatively, users are connected to an access provider 174 such as on the Web 182, using a wireless device 180, or an alternative device such as WEB TV™ 184. These users may be visiting various web sites, such as through web farms 152. For example, a web farm 152 is a group of computer systems and Web server software that collectively provide the web page delivery mechanism in a company either for internal use (such as an intranet) and/or for the Internet.

Additionally, users may be on a web site visiting a content provider 176. As shown, the message server 150 can be located at various locations. The message server 150 can interrupt an action by the user and provide the emergency information. Emergency messages can be managed and/or provided by message orientation agencies 190 or networked services 192.

FIG. 7 illustrates an overview of an exemplary embodiment of the present invention. Users, such as users using agency client computers 200 or Internet browsers 202, can connect to the Internet 204. Further, content sites 206 utilizing an emergency broadcast service, such as one using a message server, can also be connected to the Internet. Moreover, caches 214 may be equipped to assist the message server 150. Further, hosting service 208 and access providers 210 may also be connected to the Internet. Access providers may connect other users on Internet browsers 212.

In exemplary embodiments, an emergency message may be stored in a database. When an emergency message is desired to be sent to users, the cache and the message server may act to interrupt actions by the user and provide the user with the emergency message. In such embodiments, this interruption occurs because the actions that a user performs while on the Internet may go through the cache and message server. When emergency information is to be sent out and a user creates an action, the cache and message server may prevent the user from having the desired action performed, and instead display the emergency information. Alternatively, the cache and message server may allow the action to be performed, but overlay the content the user is viewing with the emergency information. As the actions of the user are going through the cache and message server, the cache and message server can control whether a user's action is to be performed or whether emergency information is to be shown to a user. Accordingly, when an emergency message is desired to be sent to the users, the message server interrupts the action and sends the emergency information.

While various embodiments of the present invention may be used on a system of networked computers, such as the Internet, the present invention may also be used on conventional distribution networks in other embodiments.

FIGS. 8 and 9 show additional embodiments that allow emergency messages to be provided to a user. In FIG. 8, message server and caches, such as a parent cache and an Internet Content Adaption Protocol (ICAP) cache, can be used. Redundancy, such as using two message servers and two caches, can enhance reliability of the system. The caches can be used to monitor when user actions occur, and the message server can be used to provide the emergency information. Computer systems can control which emergency message is sent to a user. Additionally, the computer systems can determine what time an emergency message is sent to a user.

In the example shown in FIG. 8, incoming requests are routed to a virtual host 300 or a parent cache 302 via a first virtual LAN(VLAN1) 304 based on layer 4 and layer 5 logic. Under layer 4 logic, anything that is not designated for port80 goes to parent cache 302. According to the layer 5 logic, only selected file extensions are routed to the virtual host 300. All other file extensions are routed to the parent cache 302. Selection of physical hosts within the virtual host 300 may utilize cookie switching for persistence between the message server 150 and the viewer. In the event that the message server 150 is not responding, the corresponding ICAP cache 306 will be deactivated via a second virtual LAN (VLAN2) 308. In exemplary embodiments, VLAN2 308 is a private virtual LAN that is tunneled back to a central service for it.

Multiple message servers 150 may be used to enhance delivery of emergency messages as shown in FIG. 9. For example, two of the message servers 150 may serve as a primary message queue and a back-up message queue. Additionally, cookies may or may not be used to determine whether a particular user has received the emergency message.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. A method of providing emergency information to a user computer connected to a system of networked computers, the method comprising:
receiving a first request for an action from the user computer over the system of networked computers; and
interrupting the first request for the action by sending emergency information to be displayed on the user computer to the user computer over the system of networked computers.

2. The method of claim 1, further comprising sending information that is responsive to the first request for the action to the user computer over the system of networked computers.

3. The method of claim 2, wherein sending information that is responsive to the first request for the action occurs after a predetermined amount of time.

4. The method of claim 2, wherein sending information that is responsive to the first request for the action occurs after receiving a second request for an action.

5. The method of claim 4, wherein the second request for the action comprises a request for additional emergency information generated in response to a user of the user computer clicking on a specified area in the emergency information displayed on the user computer.

6. The method of claim 5, further comprising sending additional emergency information to be displayed on the user computer in response to the second request for the action.

7. The method of claim 1, wherein the first request for the action comprises a request to view a web page.

8. The method of claim 1, wherein the emergency information is provided by a governmental entity.

9. The method of claim 1, wherein the emergency information comprises information regarding a weather related emergency.

10. The method of claim 1, wherein the emergency information comprises information regarding a computer virus.

11. The method of claim 1, wherein the emergency information is provided to a plurality of user computers.

12. A method of receiving emergency information at a user computer connected to a system of networked computers, the method comprising:
receiving a first user request for an action from a user of the user computer;
transmitting the first user request for the action to a server over the system of networked computers;
receiving emergency information in response to the first user request for the action instead of receiving information that is responsive to the first request for the action; and
displaying the emergency information on the user computer.

13. The method of claim 12, wherein the emergency information fills an entire screen display on the user computer.

14. The method of claim 12, wherein the emergency information flashes on the screen display on the user computer.

15. The method of claim 12, wherein the emergency information is displayed in a color that is noticeable.

16. The method of claim 12, further comprising receiving information that is responsive to the first request for the action.

17. The method of claim 12, further comprising receiving a second user request for an action.

18. The method of claim 17, wherein the second request for the action is a request for additional emergency information.

19. The method of claim 18, further comprising:
receiving the additional emergency information; and
displaying the additional emergency information.
